(19) United States
(12) Patent Application Publication
(10) Pub. No.: US 2021/0228321 A1
(43) Pub. Date: Jul. 29, 2021

(54) Dental Implant

(71) Applicant: Roland Estrabillo, Ancaster (CA)

(72) Inventor: Roland Estrabillo, Ancaster (CA)

(21) Appl. No.: 17/053,881

(22) PCT Filed: May 9, 2019
(86) PCT No.: PCT/CA2019/050622

§ 371 Date: Nov. 9, 2020

Related U.S. Application Data
(60) Provisional application No. 62/669,004, filed on May 9, 2018.

(51) Int. Cl. A61C 8/00

(52) U.S. Cl. CPC A61C 8/0025; A61C 2008/0046; A61C 8/0075; A61C 8/0012

(57) ABSTRACT

A novel non-metallic dental implant is provided. The implant comprises: i) a fixture to be inserted into bone, the fixture comprising a collar having a rough surface at the crest of the fixture and which tapers inwardly from a top to a neck wherein the diameter of the top is greater than the diameter of the neck, and a threaded body extending from the neck of the collar having an upper region and a lower region and comprising self-tapping threads, wherein the fixture comprises a bone compression region at the junction of the upper and lower regions of the threaded body at a site which is below the cortical bone when implanted, wherein the bone compression region comprises the widest diameter along the fixture's length; and ii) an abutment extending from the collar of the fixture. A kit comprising the dental implants is also provided.

### FIELD OF THE INVENTION

The present invention generally relates to the field of dentistry, and in particular, relates to dental implants which are characterized as self-drilling and self-tapping.

### BACKGROUND OF THE INVENTION

The field of dental implants has evolved to a great extent over the past 50 years. Conventional dental implants have been successfully used to replace a missing tooth once the bone has fully healed. Unfortunately, during this healing time, bone atrophy occurs as a result of dis-use and lack of stimulation due to the tooth loss. This could result in the requirement for multiple surgeries to successfully restore and replace a missing tooth.

Furthermore, in a majority of cases, tooth loss results from periodontal disease, but may also occur due to a failing root canal treatment, a fracture that cannot be treated with a standard treatment such as a filling, crown or root canal, due to a congenital abnormality or even due to trauma to the jawbone. In these situations, the surrounding bone structure is damaged by infection or inflammation such that sockets and bone around these teeth are usually wider than the diameter of the roots of the missing tooth. In order for a dental implant to be successful, there must be a sufficient amount of healthy bone, including height, width and healthy blood supply, at the implant site in order to establish a good initial retention of the dental implant.

Research has also shown that up to 5-7% of the population experience an adverse reaction to metallic dental implants, such as titanium or titanium alloy dental implants, as a result of bio-tribocorrosion.

A variety of dental implants are currently on the market; however, dental implant manufacturers do not provide implants to meet all needs, for example, do not provide implants in a sufficient variety of sizes, made of optimal materials, and with desirable placement features such as self drilling/tapping threads designed for optimal initial osscointegration. As a result, the clinician is required to use and stock different systems for use to place implants from different sources, with different drill sets, including pilot drills, tapping drills and countersink drills, different implant parts, healing abutments, cover screws, and the like, for each different type of implant used.

Thus, the process of installing a dental implant generally comprises multiple steps, including the requirement for extensive preparation of the implant site and the need to sterilize instruments numerous times which increases the risk of potential contamination and infection.

In view of the foregoing, it would be desirable to develop a dental implant that overcomes one or more of the disadvantages of current dental implants.

### SUMMARY OF THE INVENTION

A novel dental implant has now been developed that is readily installed comprising a biocompatible fixture with a configuration that preserves surrounding bone and promotes bone growth.

In one aspect, a non-metallic dental implant is provided comprising: i) a fixture to be inserted into bone, the fixture comprising a collar at the crest of the fixture having a rough surface and which tapers inwardly from a top to a neck wherein the diameter of the top is greater than the diameter of the neck, and a threaded body extending from the neck of the collar having an upper region and a lower region and comprising self-tapping threads, wherein the fixture comprises a bone compression region at the junction of the upper and lower regions of the threaded body, wherein the bone compression region comprises a diameter which is the widest along the fixture's length; and
ii) an abutment extending from the collar of the fixture.

A kit is provided in another aspect of the invention comprising two or more non-metallic dental implants as defined above, wherein the implants comprise collars having tops of different diameters.

These and other aspects of the invention will become apparent in the following detailed description and by reference to the following figures.

### BRIEF DESCRIPTION OF THE FIGURES

FIG. 1 A-D illustrates dental implants in accordance with an embodiment of the invention, including an implant having a width (diameter of collar top) of 4.2 mm (A), 5 mm (B), 7 mm (C) and 9 mm (D);

FIG. 2 illustrates an expanded view of self-tapping threads of the implant of FIG. 1;

FIG. 3 illustrates different sizes of dental implants (A) with an integrated abutment, and (B) with an abutment which is separate; and

FIG. 4 illustrates an expanded view of the fixture collar and integrated abutment.

### DETAILED DESCRIPTION OF THE INVENTION

A non-metallic dental implant is provided comprising: a fixture to be inserted into bone, the fixture comprising a collar at the crest of the fixture having a rough surface and which tapers inwardly from a top to a neck, and a threaded body extending from the neck of the collar having an upper region and a lower region and comprising self-tapping threads, wherein the fixture comprises a bone compression region at the junction of the upper and lower regions of the threaded body at a site which is below the cortical bone when implanted, i.e. below the cortical plate or layer of compact bone that overlies the spongiosa of the alveolar process on the mandible and maxilla, wherein the bone compression region comprises the widest diameter along the fixture's length; and an abutment extending from the upper collar of the fixture.

The present dental implant is non-metallic. Examples of non-metallic materials the implant may be made of include, but are not limited to, aluminum oxide, zirconium oxide, yttrium-stabilized zirconium oxide (ZrO₂/Y₂O) and combinations thereof, optionally strengthened with aluminum oxide (Al₂O₃). The non-metallic feature of the implant prevents any adverse reaction to nano-particles that some patients experience with metallic implants. It also prevents tribo-corrosion (degradation due to the combined effect of corrosion and wear). Further, no additional surface layer coating is required to promote osseointegration as is often required with metallic implants. An additional advantage provided by this material is its white colour which permits placement of the margin of the implant very close to the crest of the gum without compromising the aesthetics. Placement of the margin at the crest of the gum also prevents cement from going below the gumline which interferes with epithelial adherence. With metallic implants, such as titanium implants, such placement is not possible as it results in a visible dark halo at the gumline which is aesthetically undesirable.

The present implant comprises a fixture component and an abutment for attachment to a prosthesis. The fixture component is the part of the implant that is embedded within the jawbone, and comprises a collar as the upper part of the fixture body and a threaded portion as the lower part of the fixture body.

The upper body of the fixture, referred to herein as the “collar”, is situated above the crest of the bone when implanted. The collar comprises a rough surface which promotes osteoblast, epithelial cell and fibroblast adherence to provide a hermetic seal with the epithelium. The phrase “rough surface” refers to a surface which incorporates deviations or irregularities from a surface that is a perfectly smooth or flat (e.g. a true plane). Roughness may be indicated as the Roughness Average (Ra) of a surface, a measure of the microscopic peaks and valleys. The greater the Ra, the greater the roughness. Roughness may be achieved by additive or subtractive processes. Examples of additive processes include application of hydroxyapatite (HA) or calcium phosphate coatings, titanium plasma sprayed, ion deposition and oxidation. Examples of subtractive processes include electropolishing, mechanical polishing, blasting (e.g. with sand or other particles), etching (e.g. with acid) and laser micro-texturing.

In one embodiment, the collar of the present implant has a surface roughness of about 1.5-2.2 microns, and preferably 1.7 to 2.0 microns.

In another embodiment, the full length of the fixture comprises a rough surface, e.g. a surface roughness of about 1.5-2.2 microns, and preferably 1.7 to 2.0 microns.

The collar of the fixture is tapered inwardly from its top to form a narrowed neck at the junction with the threaded lower body of the fixture. The top of the collar may range in diameter from about 2-9 mm, and may taper to a diameter 1-2 mm less at the narrowed neck of the collar. The narrowed neck of the collar, which is situated at the crest of the jawbone when implanted, advantageously reduces the size of the hole required in the jawbone for implant placement, thereby preserving cortical bone, and minimizing compression on the cortical bone that may cause early or premature bone resorption due to the implant.

The threaded portion of the fixture comprises threads that may assume various thread geometries including thread pitch, depth, width, helix angle, face angle and overall shape. The pitch is the distance from the center of one thread to the center of the adjacent thread. The greater the pitch, the less the number of threads on the fixture. Thread depth is the distance from the edge of the thread to the body of the implant. Face angle is the angle from the face of the thread to a plane perpendicular to the longitudinal axis of the implant. Shape is based on the combined result of the other features of the implant (pitch, depth, width, helix and face angles). Examples of thread geometries include, but are not limited to, V-shape, square, buttress, reverse buttress and spiral.

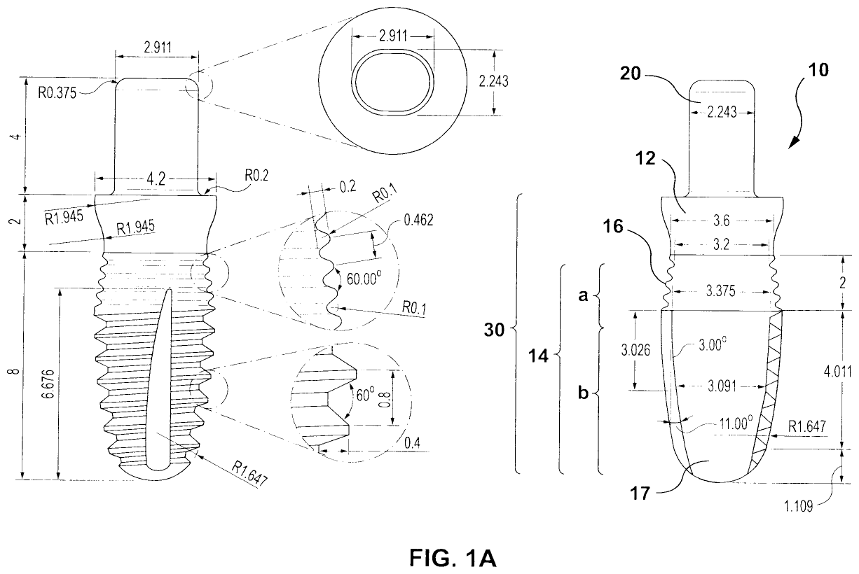

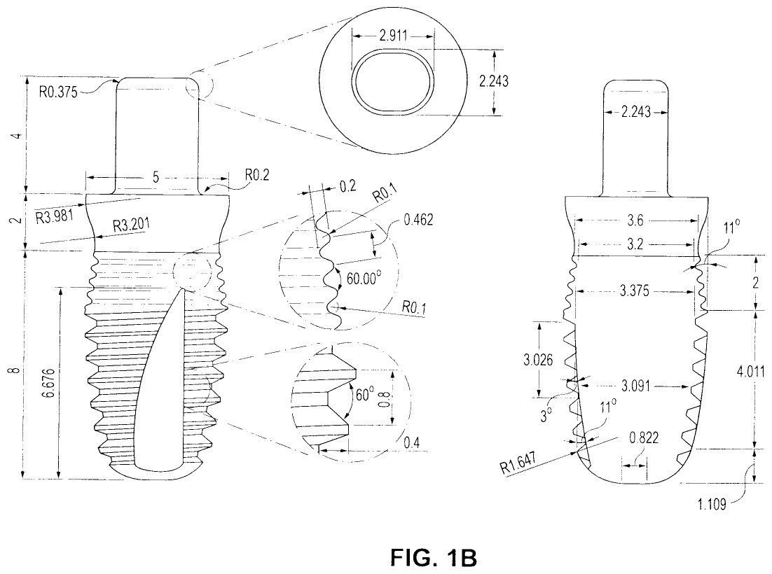

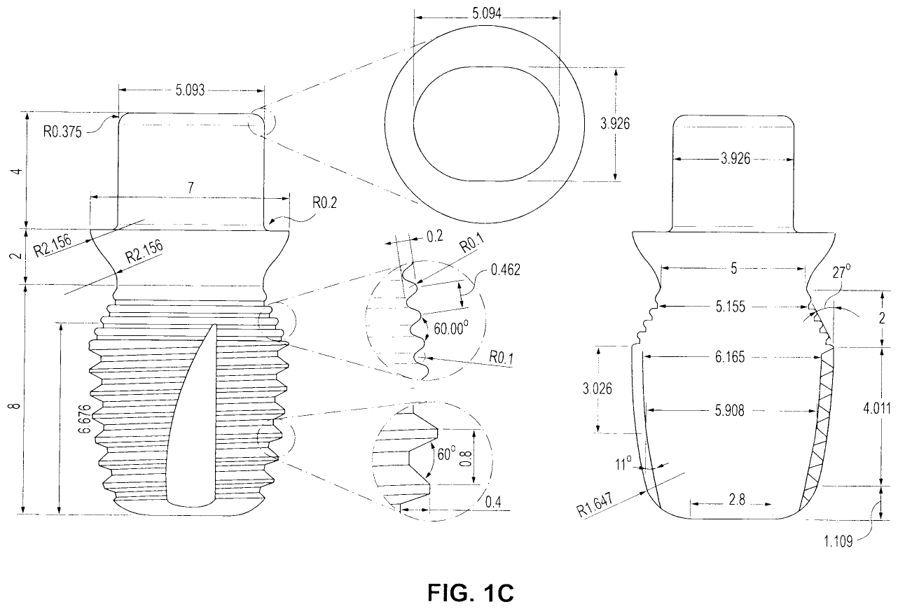

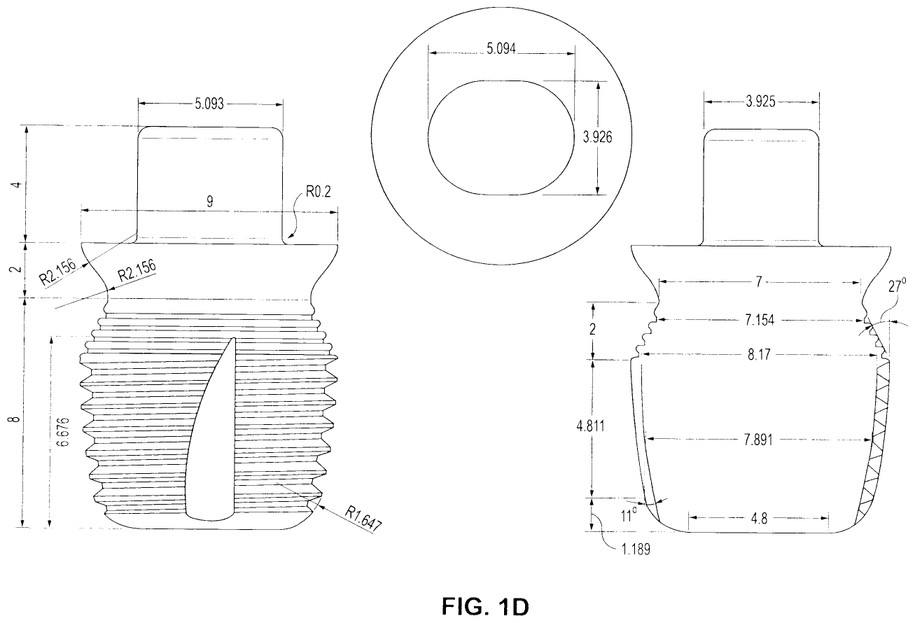

In one embodiment, the face angle of the threading may in the range of about 55° to 65°, e.g. about 60°. The threads of the fixture's lower body may have a pitch in the range of 0.3-0.9 mm. The pitch of the threads may be the same along the entire length of the threaded portion of the fixture. Alternatively, the threading adjacent to the implant collar (upper threaded region) may have a lesser pitch, e.g. of about 0.3-0.55 mm, 0.4-0.5 mm, and the subsequent threading (e.g. beyond the widest diameter of the fixture as shown in FIG. 1 or the lower threaded region) on the remainder of the fixture's threaded portion may have a greater pitch, e.g. of about 0.7-0.9 mm, such as 0.75-0.85 mm. The thread depth may be in the range of about 0.2-0.5 mm. The thread depth may be the same or different along the length of threaded portion of the fixture. For example, the threading adjacent to the implant collar (the upper region) may have a lesser depth, e.g. of about 0.2 mm, and the subsequent threading (the lower region) may have a greater depth, e.g. of about 0.4 mm. Threads having a lesser pitch and/or depth provide a greater number of threads over a given length, e.g. provide a fine thread region, and therefore, greater surface contact between the implant and the surrounding bone. This is advantageous within the upper region of the threaded portion which is embedded in the most dense bone region (i.e. corticol bone). Threads having a greater pitch and/or depth provide less threads over a given length, e.g. provide a coarse thread region. In another embodiment, the threading of the fixture is fine in the upper threaded region, and coarse in the lower threaded region.

The threaded portion of the fixture is self-tapping, e.g. incorporates a groove or flute formed along the length of the lower threaded region which may preferably comprise a course thread. The flute has a rake angle of 20-60 degrees with a depth of about 0.1 to 0.5 mm into the body of the implant and spirals around the lower threaded region. The flute provides a cutting edge to enable entry of the fixture into the bone without pre-tapping of the bone.

The widest diameter of the fixture, herein referred to as the bone compression region, is situated within the threaded portion where the upper region meets the lower region and is below the crest of the bone when implanted. In one embodiment, this widest diameter occurs at about 1-3 mm below the collar of the implant to be situated 1-3 mm below the crest of the bone when implanted, e.g. at about 2 mm below the collar of the implant or crest of the bone when implanted. The widest diameter of the fixture may range in size from about 2-9 mm, and may, thus, coincide in size with the diameter of the top of the collar. The bone compression region spans about 1-3 mm of the fixture. The presence of the bone compression region below the crest of the bone when implanted results in the greatest bone compression occurring below the crest of the bone on placement of the implant, and prevents early bone loss of the crestal cortical bone. Thus, this implant configuration is advantageously osteogenic, stimulating new crestal cortical bone growth.

The fixture of the implant is designed for placement into a bone site including an existing or pilot hole prepared with a pilot drill, which may require drilling with a series of drills to widen or increase the depth of the hole. However, provision of the present implant minimizes the amount of drilling required due to the provision of the present implant in multiple dimensions for fitting into molar holes, and fitting into smaller tooth holes such as premolar, canine and incisor holes. For example, the implant may be provided with widths (i.e. the diameter of the top of the collar) ranging from about 2 to 9 mm and heights ranging from about 8 to 18 mm. For example, implants may be provided having a width of 2, 4.2, 5, 7 or 9 mm, and a height of 8, 10, 12, 14 or 16 mm. These dimensions are believed to accommodate implants for all sizes of teeth, from the narrowest lower incisors to the widest molars.

The abutment of the implant extends from the top of the collar of the fixture, and functions to receive the prosthesis, which may be a crown, bridge or denture. Thus, the abutment is configured to permit the prosthesis to be affixed thereto in an effective manner. In one embodiment, the abutment assumes an anti-rotational cross-sectional shape, i.e. a cross-sectional shape that prevents rotation of the prosthesis on the fixture. For example, the cross-sectional shape of the abutment may be oval, rectangular, square, polygonal (either a regular or irregular polygon) or another shape that does not permit ready rotation. In a preferred embodiment, the abutment has an oval cross-section.

The abutment may be a separate entity which is attached to the fixture once the fixture is embedded in the bone. Generally, the abutment is attached by screwing it into or cementing onto a platform on the surface of the fixture in which there is formed a threaded receptacle to receive the screw. The platform between the implant and the abutment may be flat (buttress) or conical in shape. In conical fit abutments, the collar of the abutment sits inside the fixture which allows a stronger junction between the fixture and the abutment to provide a seal that functions to prevent bacterial growth within the implant body.

Alternatively, the abutment may be integral with the fixture. The use of a one piece integrated dental implant offers significant advantages. First, an integrated implant is stronger, and avoids the potential that the connection (e.g. screw) between the abutment and the fixture will loosen or break. The use of an implant having an integrated abutment also eliminates the microgap between the abutment and the implant body or fixture, eliminating the potential for bacterial growth therein. In addition, the integrated implant eliminates the need for subsequent surgery to install the abutment. Further, an integrated implant avoids the possibility of cement getting below the gumline when the abutment is attached, resulting in improved cosmetic results. Such an integrated implant may be prepared using established techniques, utilizing moulds to provide an implant shaped as desired.

Placement of an implant in accordance with the present invention is conducted using established techniques. If the implant is for placement at a site where an open hole does not exist, then an incision must first be made to expose the crest of bone, splitting the thicker attached gingiva roughly in half so that the final implant will have a thick band of tissue around it. The edges of tissue, each referred to as a flap are pushed back to expose the bone. Flapless surgery is an alternate technique, where a small punch of tissue (the diameter of the implant) is removed for implant placement rather than raising flaps. Once the bone is exposed, a pilot hole is made with a precision drill at highly regulated speed to prevent burning or pressure necrosis of the bone. Minimal further drilling is required due to the provision of the present implant in a variety of sizes, for example, further drilling to form a hole two (2) dimensions less than the final required implant size is appropriate since the present implant can readily be placed in such a hole due to the variable sizes provided and other features of the implant, e.g. self-tapping feature.

The self-tapping fixture is then screwed into place. If the implant does not include an integrated abutment, abutment placement is done at a later appropriate time once sufficient healing and bone integration following placement of the fixture has occurred.

Alternatively, the present implant may be placed into an existing hole, for example, immediately following extraction of a tooth. When this is done, most of the socket preparation is already done, and additional drilling is often not required. This is also more convenient for the patient because it avoids the need and associated risk of additional surgery and anesthetization. Further, bone height and width are preserved, and vital organs such as the maxillary sinuses and inferior alveolar nerve are not encroached minimizing the risk of potential damage to these vital tissues.

The present implant provides several advantages over existing implants.

At the outset, the present implant is non-metallic and, thus, is acceptable for use in individuals that may be sensitive to metals. From a surgical point of view, it is simpler to install the present implant. It does not require the use of multiple sets of drills. Once the pilot hole has been created with a pilot drill, further drilling with regular twist drills only up to 2 sizes smaller than the final implant size is required in order to place the implant due to the variety of sizes in which the implant is provided. The use of further drills, e.g. a countersink drill, and a tapping drill, thus, is not required. Further, the implant comprises self-drilling and self-tapping threads incorporating a flute to create its own osteotomies to engage with the implant hole. The threads are designed with increased surface area to achieve bone adherence, and act as scaffolding for the new bone growth due to their osteoinductive and osteoconductive properties. The implant may also be provided with an integrated abutment, further reducing the surgical time required to complete placement of the implant.

In sum, the present implant is more biocompatible, more readily placed, requiring less time, equipment and cost, and as a result, provides a safer and more affordable implant process.

In one embodiment of the present invention, a kit is provided comprising the present dental implant in multiple height and/or width dimensions. Such a kit advantageously provides an implant that fits into an existing hole with minimal surgical intervention. Such kits may include various combinations of differently sized implants. For example, a kit may comprise implants of fixed width (diameter of collar top) and variable height (length from collar top to bottom of the fixture), fixed height and variable width, or variable width and height. Thus, the kit may comprise implants with a fixed width of, for example, 2 mm, 4.2 mm, 5 mm, 7 mm or 9 mm, and heights of, for example, 8, 10, 12, 14, 16 or 18 mm, or implants of a fixed height of 8, 10, 12, 14 or 16 mm, and variable widths of 2 mm, 4.2 mm, 5 mm, 7 mm and 9 mm, or implants with variable widths of 2 mm, 4.2 mm, 5 mm, 7 mm and 9 mm, with each width provided at variable heights of 8, 10, 12, 14 and 16 mm. The provision of a kit providing implants with a range of widths and/or lengths enables the surgeon to apply minimal surgery/drilling to the bone, and to select the appropriate-sized implant to preserve existing bone even after bone destruction due to resorption from infection, inflammation or trauma.

Embodiments of the invention are described in the following specific example which is not to be construed as limiting:

### Example

A dental implant 10 according to an embodiment of the invention is shown in FIG. 1A. The implant 10 comprises a fixture 30 (10 mm in length). The fixture 30 includes an upper collar 12 (2 mm long) and a lower threaded body 14 (8 mm long). The upper collar 12 tapers from the widest diameter of the implant of 4.2 mm to 3.2 mm at the junction with the threaded body 14. The threaded body 14 comprises an upper region (a) having fine threading (e.g. a pitch in the range of about 0.4-0.5 mm) and a lower region (b) having coarse threading (e.g. a pitch in the range of about 0.75-0.85 mm). A flute is formed in the threaded body 14 which essentially extends for the length of the coarse threading (b). An integral abutment 20 extends (4 mm) from the upper collar 12 of the fixture. The abutment 20 is oval in shape, having a length-wise dimension of about 2.9 mm and a width-wise dimension of about 2.2 mm.

FIGS. 1B-1D illustrates dental implants in accordance with other embodiments with modified widths (widest width of upper collar 12) of 5, 7 and 9 mm, respectively, tapering to a width of about 4, 5 and 7 mm, respectively, at the junction with the threaded body 14. Other dimensions are the same or similar to those shown in FIG. 1A.

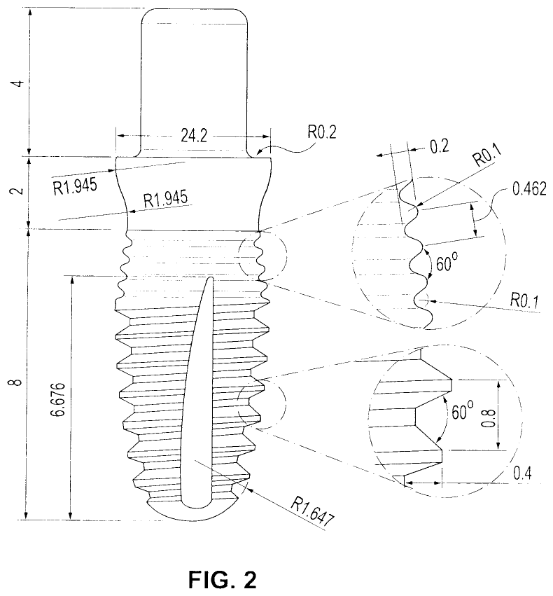

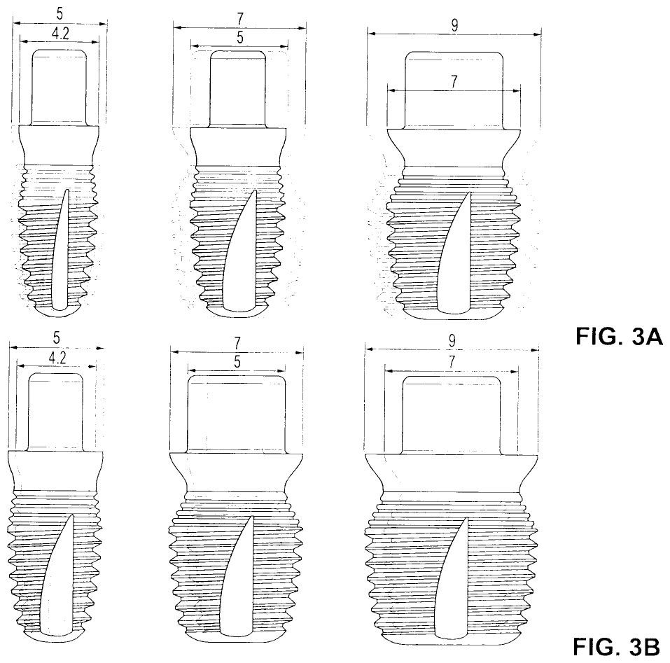

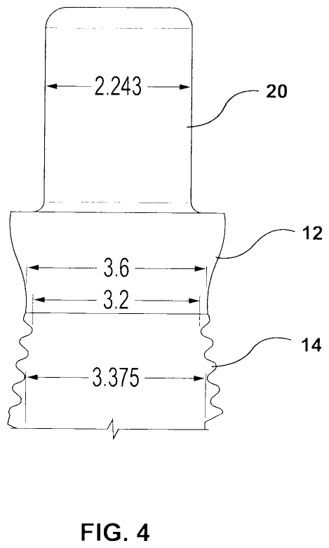

FIG. 2 illustrates the dimensions of the fixture 30, including the upper (a) and lower (b) threaded regions of the threaded body 14, and FIG. 4 illustrates the integrated abutment 20. The widest part of the threaded body is the bone compression region 16 which occurs at about the junction of the upper and lower regions of the threaded body 14. A flute 17 is formed in the lower region of the threaded body 14.

1. A non-metallic dental implant comprising:
i) a fixture to be inserted into bone, the fixture comprising a collar at the crest of the fixture having a rough surface and which tapers inwardly from a top to a neck wherein the diameter of the top is greater than the diameter of the neck, and a threaded body extending from the neck of the collar having an upper region and a lower region and comprising self-tapping threads, wherein the fixture comprises a bone compression region at the junction of the upper and lower regions of the threaded body at a site which is below the cortical bone when implanted, wherein the bone compression region comprises the widest diameter along the fixture's length; and
ii) an abutment extending from the collar of the fixture.

2. The implant of claim 1, made of aluminum oxide, zirconium oxide, yttrium-stabilized zirconium oxide or combinations thereof.

3. The implant of claim 1, wherein the fixture and abutment are integral.

4. The implant of claim 1, wherein the surface of the upper collar has a roughness of about 1.7-2.0 microns.

5. The implant of claim 1, wherein the surface of the fixture has a roughness of about 1.7-2.0 microns.

6. The implant of claim 1, wherein the bone compression region is situated 1-3 mm below the neck of the collar.

7. The implant of claim 6, wherein the widest diameter of the fixture is situated 2 mm below the crest of the collar.

8. The implant of claim 1, wherein the widest diameter of the fixture is in the range of 2-9 mm.

9. The implant of claim 1, wherein the widest diameter of the fixture corresponds with the diameter of the top of the collar.

10. The implant of claim 1, wherein the pitch and/or depth of the threads in the upper region of the threaded body is less than the pitch and/or depth of the threads in the lower region of the threaded body.

11. The implant of claim 1, wherein the pitch of threads in the threaded body is in the range of 0.3-0.9 mm.

12. The implant of claim 10, wherein the pitch of the threads in the upper region of the threaded body is in the range of 0.3-0.55 mm, and pitch of the threads in the lower region of the threaded body is in the range of 0.7-0.9 mm.

13. The implant of claim 1, wherein the face angle of the threading is in the range of 55° to 65°.

14. The implant of claim 1, wherein the depth of threads in the threaded body is in the range of about 0.2-0.5 mm.

15. The implant of claim 1, wherein the threaded body comprises a flute formed in the lower region of the threaded body.

16. The implant of claim 14, wherein the flute has a depth of 0.1-0.5 mm.

17. The implant of claim 14, wherein the flute has a rake angle of 20-60 degrees.

18. A kit comprising multiple dental implants as defined in claim 1, wherein the implants comprise collars having tops of different diameters.

19. The kit of claim 18, comprising implants having collar tops ranging in size from 2-9 mm in diameter.

20. The kit of claim 18, comprising implants having collar tops with diameters of 2 mm, 4.2 mm, 5 mm, 7 mm and/or 9 mm.

21. The kit of any one of claims 18-20, comprising implants having heights ranging from 8-18 mm.
